(19) United States
(12) Patent Application Publication
(10) Pub. No.: US 2005/0283916 A1
(43) Pub. Date: Dec. 29, 2005

(54) Multiple use hand tool and wearable hand tool organizer

(76) Inventor: Gary Gintz, Boise, ID (US)

Correspondence Address: DEREK H. MAUGHAN;DYKAS, SHAVER & NIPPER, LLP, PO BOX 877, BOISE, ID, 83701-0877, US

(21) Appl. No.: 11/166,688

(22) Filed: Jun. 23, 2005

Related U.S. Application Data
(60) Provisional application No. 60/583,043, filed on Jun. 25, 2004.

(51) Int. Cl. B25D 1/04

(52) U.S. Cl. 7/144

(57) ABSTRACT

A system of tools for use by an electrician made up of three principle parts; a hammer holster, a specialized hammer and a fastener holder. The hammer is comprised of a head with a single claw having a generally bell-shaped portion and terminus connected to a handle. The handle is configured to receive a portion of a wire-cutting device therein. The holster and the fastener holder are each configured for connection with a belt, such as are commonly used by individuals in various construction trades. The holster includes a rotatable magnetic portion that is configured to rotatably connect and attach to a metal portion of another tool such as a hammerhead. A clasp is preferably fixedly connected to the holster and acts to hold the handle of a hammer within the clasp when the hammer is positioned in a designated position and orientation. The fastener holding device includes a magnetic portion connected to a belt-connecting portion.

### PRIORITY

This application claims the priority date of the provisional application entitled MULTIPLE USE HAND TOOL AND WEARABLE HAND TOOL ORGANIZER filed by Gary Gintz on Jun. 25, 2004 with application Ser. No. 60/583,043.

### BACKGROUND OF THE INVENTION

1. Field of the Invention

The present invention generally relates to hand tools and more particularly to a set of hand tools specialized for use by electricians, as well as a carrying device for holding these tools.

2. Background Information

Installing electrical wiring within a commercial or residential structure requires the interaction of a variety of components and pieces which must he interconnected and secured to various physical locations within the building. The proper installation of these pieces allows the proper functioning of these components as well as the safety to the building and the associated persons functioning therein.

In performing these installation functions, a variety of tasks must be performed. Wire must be hung, outlet boxes must be installed and a variety of other tasks must also take place. Typical construction tools such as framing hammers are bulky and awkward and are not easily manipulated or useable in performing such tasks. Typical aprons and tool belts which are utilized by many persons in the construction industry are also awkward and bothersome as storage locations for tools such as hammers, pliers and wire strippers, as well as for various types of fasteners such as wire staples. Therefore what is needed is a tool and system of tools and storage devices which are specialized for electricians and which allow these persons to access and use a variety of tools in a way that is more efficient and comfortable as compared to other devices and items which exist in the prior art. The present invention fulfills this need.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a tool set that allows a workman, such as an electrician, to more effectively and efficiently complete designated tasks. While the present preferred embodiment of the invention is presented, it is to be distinctly understood that the invention is not limited to this specific embodiment, but may be variously understood and described within the meets and bounds set forth in the attached claims.

In the preferred embodiment of the present invention, the invention is a system of tools for an electrician made up of three principle parts: a hammer holster, a specialized hammer and a fastener holder. The holster and the fastener holder are each configured for connection with a belt, such as are commonly used by individuals in various construction trades. In some embodiments, the configuration of the belt connection device includes a clip which fits over the belt while in other embodiments the belt connecting portion of the holster could be molded, sewn, riveted or otherwise connected to a typical tool belt device.

The holster of the present invention is comprised of a body, which extends from a first end to a second end. A rotatable magnetic portion is connected near the second end of the device and is configured to rotatably connect and attach to a metal portion such as a hammer head. A clasp is preferably fixedly connected to a portion of the body and acts to hold the handle of a hammer within the clasp when the hammer is positioned in a designated position and orientation. A hammer can be alternatively attached and removed from connection with this device by placing the head of the hammer against the pivoting magnetic head and rotating the handle of the device upward so as to fit the handle within the clasp connected to the body of the device. The hammer can be withdrawn from such a holster by similarly reversing the steps so as to remove the handle of the device from its position within the clip and rotating the handle downward and pulling the head of the hammer away from the pivoting magnetic head.

In the preferred embodiment, the belt loop and the holster lie in different vertical planes than the plane defined by the handle of the hammer when the hammer is connected to a magnetic head holding portion.

In addition to holding hammers of various sizes and weights, the holster could also be used by persons in other professions and hobbies such as gardeners, groomers, and other persons who have metal tools that must be both stored to allow use of both hands, but must also be quickly and easily accessible for use.

Another part of the present invention is a novel and improved electrician's hammer This hammer is comprised of a head which is fixedly connected to a handle. The handle has a body with a portion that is configured to receive a portion of a wire-cutting device therein. The head of the hammer contains a single claw. This single claw is dimensioned to allow a user to insert the claw within portions of electrical connection devices, such as a junction box, and to break portions of this device out so as to accommodate the pulling of wire through the aperture. This single claw is also configured to have the handle of a lesser angle than those shown in the prior art. The single claw further comprises a generally bell-shaped portion and its terminus, which allows a user increased ability to pull and remove fasteners with significantly decreased amounts of damage to an underlying surface. In the preferred embodiment, the wire-cutting device is shown connected to the hammer, and is a wire-stripping tool comprised of a pair of jaws connected to levers around a central pivoting point. The levers when compressed also exert a force upon the jaws which are configured to cut a piece of wire in a designated way. While in the preferred embodiment a wire stripper is shown, it is to be distinctly understood that a variety of other types of wire trimming devices could also be employed and are considered within the scope of the present invention.

The system of the present invention also comprises a fastener holding device. In one embodiment of the invention this fastener-holding device is a magnet which is connected to a belt loop. This magnet holds the fasteners which are to be used and are placed upon the outer surface of the pouch in a desired position and orientation. In the preferred embodiment, a tray is connected to the lower portion of the pouch so as to allow the number of fasteners, which are connected to the device to be held in this designated location. This improved fastener holding device is an improvement over prior art devices such as pouches, which limit the ability of the user to withdraw fasteners, and further can cause pain and injury to the user as fingers are poked when attempting to remove a fastener from within a pouch. While all three of theses features are shown, it is to be distinctly understood that the various pieces of this device may also be embodied and utilized separately with other prior art embodiments. It is also to be distinctly understood that various obvious modifications may also take place while with these devices, which modifications would also be included with and disclosed of the present invention.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is perspective view of the system of the present invention.

FIG. 2 is a detailed view of the holster and fastener holder of the present invention used in connection with a standard hammer.

FIG. 3 is a front plan view of a variety of holster embodiments used in the present invention.

FIG. 4 is a detailed front view of the hammer of the present invention in place upon the holster of the present invention.

FIG. 5 is detailed perspective view of the head of the hammer shown in FIG. 4.

FIG. 6 is detailed perspective view of the hammer shown in FIG. 4 in use.

FIG. 7 is a perspective view of the present invention in use upon the tool belt of a user.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

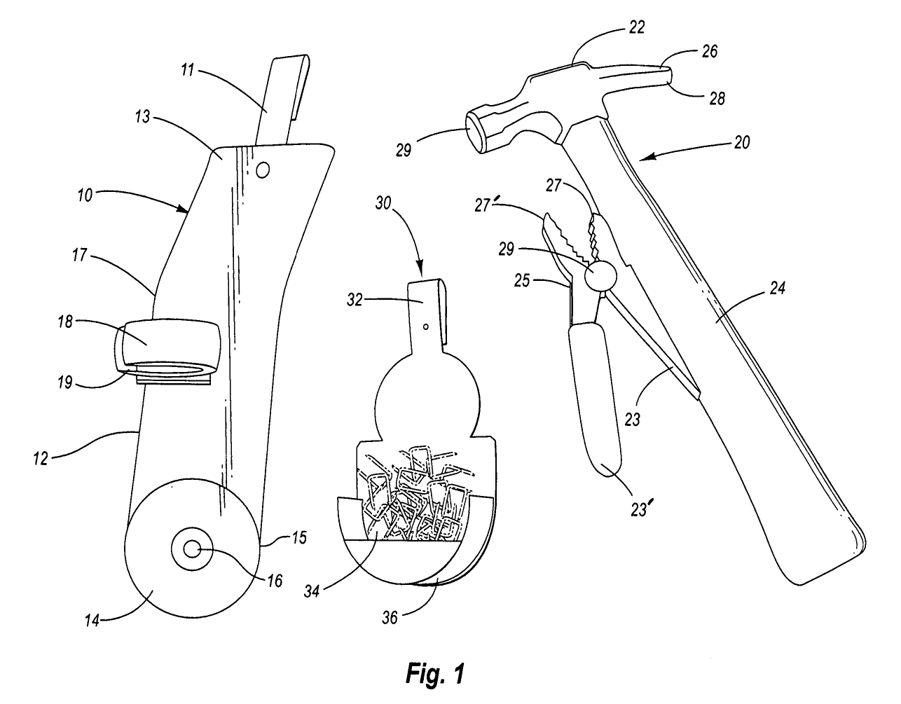

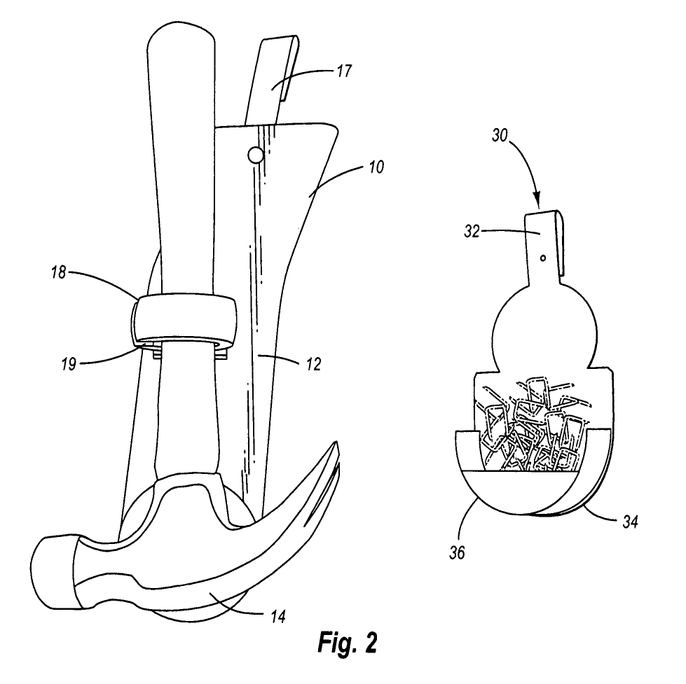

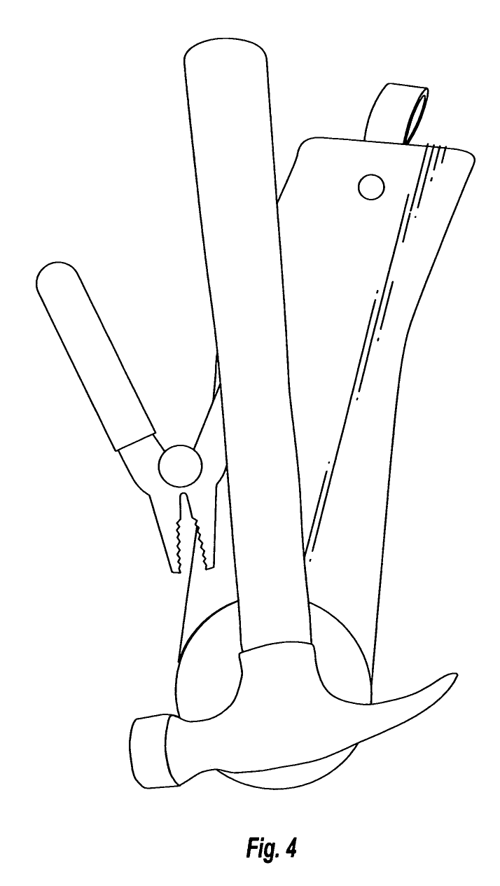

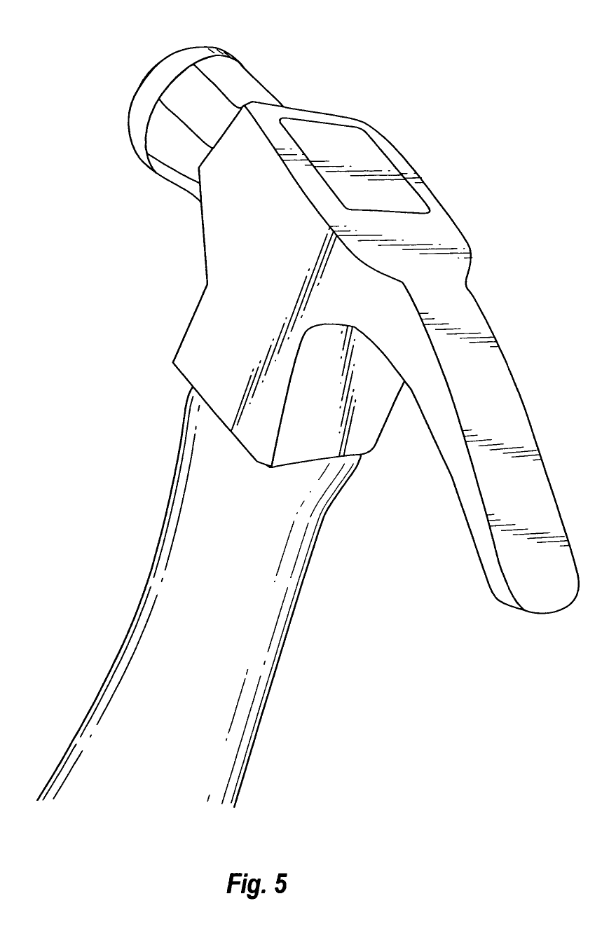

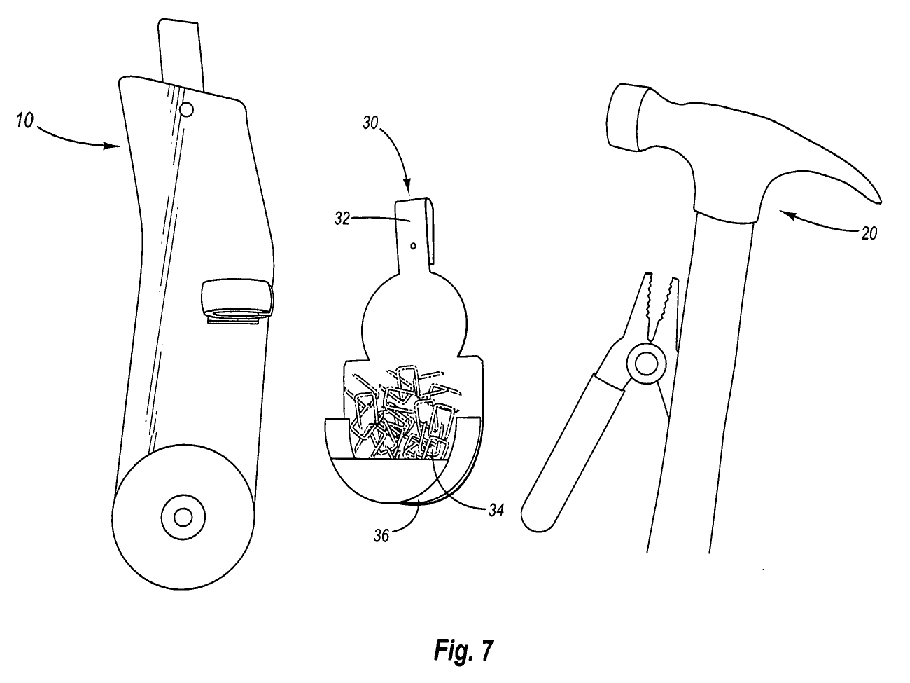

Referring now to the attached FIGS. 1-7, a variety of views of the preferred embodiment of the present invention are shown. FIG. 1 shows the system of tools described in the preferred embodiment of the present invention. In the preferred embodiment of the present invention, the system of tools for an electrician is made up of three principle parts: a hammer holster 10, a new and inventive hammer 20, and a new and novel fastener holder 30. The holster 10 and the fastener holder 30 are each configured for connection with a belt, such as are commonly used by individuals in various trades. While in the preferred embodiment the connection with a belt is shown, it is to be distinctly understood that the invention could also be utilized in those embodiments where such a connection is not possible or desired. Such a configuration includes situations where the holster could be molded and sewn, or otherwise connected to a typical tool belt device, which is known and common in the prior art.

The configuration of the belt connection portion to these devices is typically a folded metal piece that is configured to slip over the top portion of a belt. While in the preferred embodiment this embodiment is shown, it is to be distinctly understood that a variety of other types of belt connecting devices may be utilized, and that this feature may also be sewn or otherwise permanently attached to a workman's belt.

Referring now first to the item designated as 10 in FIG. 1, the holster of the present invention is comprised of a body 12, which extends from a first end 13 to a second end in a generally dogleg shaped type of device. In this embodiment, the holster 10 is shown in a right handed configuration and it will be understood and appreciated that the application is not limited thereto, but may be variously embodied to facilitate the use by a left handed user. The modification of the present invention so as to allow use by a left handed user would require the altering of the position of the dogleg portion 17 of the holster 10 and rearranging the clasp portion 18, so as to allow the handle of a hammer to be withdrawn by pushing the device downward with one's left hand. In the preferred embodiment, the belt connection portion 11 is pivotally connected to the top end of the device 13 through a fastener. This fastener holds the holster to a belt and allows the body 12 of the dogleg shaped holster to be suspended in a generally vertical orientation. As discussed previously, this connection is not limited to the metal folded device shown in the attached figures, but may be configured for connection in any one of a variety of tool belts, common belts, or suspenders.

Near the second end of the holster body 15 a generally circular shaped magnetic piece 14 is rotatingly connected to the holster body portion 12 through a fastener 16. This generally circular magnetic piece 14 is configured to rotate about the axis between the holster 12 and the fastener 16. This allows a hammer having a metal head to be magnetically connected to the magnetic head, and to be suspended in a generally vertical plane along the body of the user. In the preferred embodiment, the plane in which the connection between the belt loop 11 and the holster 12 lies, is a different vertical plane than the plane defined by the handle of the hammer when the hammer is connected to a magnetic head holding portion 14. In the preferred embodiment, the holster 12 further comprises a clasp 18. The clasp 18 is generally a C-shaped portion that is configured to receive and hold a handle of a device therein. The handle of the hammer is retained within the generally C-shaped portion by a tab 19. This tab 19 and the C-shaped portion 18 are made up of a material with sufficient rigidity to hold the hammer handle in the desired position and orientation. However, this material also has sufficient flexibility so as to allow these portions to be pulled back, and allow the hammer to be removably inserted and removed therefrom. In the preferred embodiment, the clasp 18 and the holster body 12 are molded as one continuous piece. However, it is to be distinctly understood that the invention is not limited thereto, but may be variously embodied to be manufactured and created from a variety of other pieces as well.

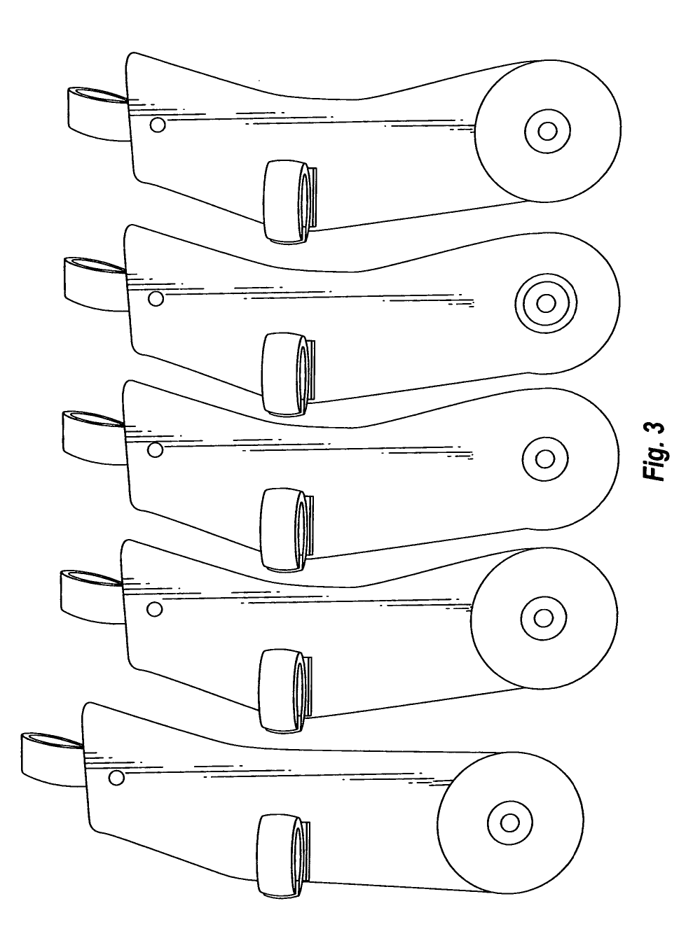

While this holster 10 is described as a hammer holster and this hammer holster is described in conjunction with a particular type of electrician hammer, it is to be distinctly understood that the holster is not limited in its use to this single type of device, but may be with any type of hammer or other tool that has a metal portion that will be magnetically attracted and held in position upon the pivoting magnetic portion. In addition to holding hammers of various sizes and weights, the holster could also be used by persons in other professions and hobbies such as gardeners, groomers, and other persons who have metal tools that must be both stored to allow use of both hands, but must also be quickly and easily accessible for use. View of variety of types of holsters are shown in FIG. 3.

Another part of the present invention is a novel and improved electrician's hammer 20. This new and novel electrician's hammer 20 is comprised of a head 22, which is fixedly connected to a handle 24. The handle 24 has a body that has a portion configured to receive a portion of a wire-cutting device 26 therein. The head 22 of the hammer contains a single claw 26. This single claw 26 is dimensioned to allow a user to insert the claw 26 within portions of electrical connection devices, such as a junction box, and to allow portions of this box to be broken out so as to accommodate the pulling of wire there through. This single claw 26 is also configured to have the handle of a lesser angle than those shown in the prior art. The single claw 26 further comprises a generally bell-shaped portion 28 in its terminus. This bell-shaped portion allows a user increased ability to pull and remove fasteners with significantly decreased amounts of damage to an underlying surface. In the preferred embodiment, the wire-cutting device 25 is shown connected to the hammer, and is a wire-stripping tool comprised of a pair of jaws 23 connected to levers around a central pivoting point 29.

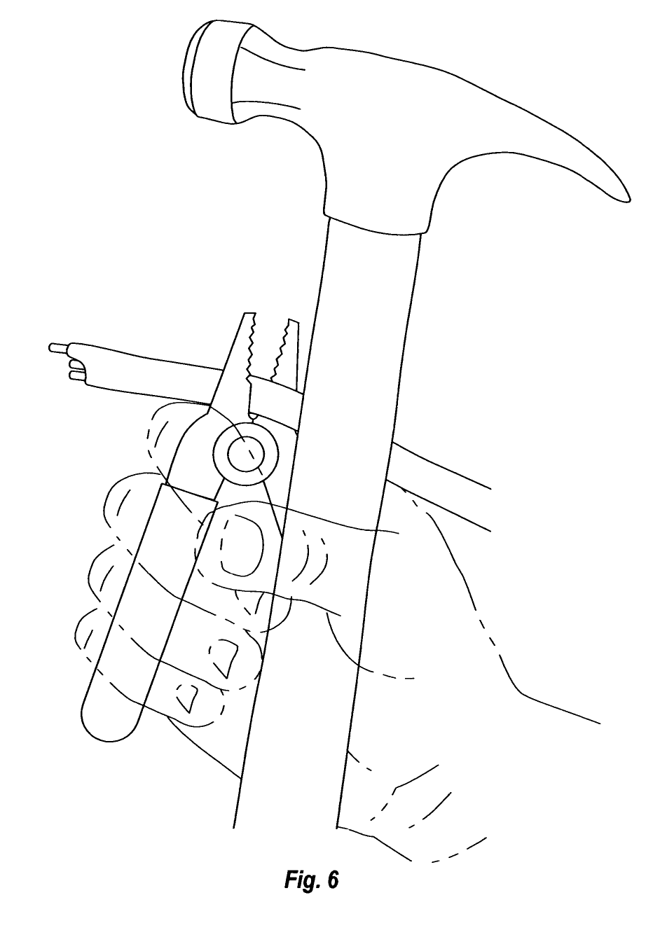

The levers 23,23′ when compressed, exert a force upon the jaws 27, 27′ which are configured to cut a piece of wire in a designated way. An example of such use is shown in FIG. 6 While in the preferred embodiment a wire stripper is shown, it is to be distinctly understood that a variety of other types of wire trimming devices could also be employed and are considered within the scope of the present invention.

The system of the present invention also comprises a fastener holding device 30. This fastener-holding device is comprised of a belt connection portion 32 connected to a magnetized back plate 34. In the preferred embodiment, this magnetic back plate 34 also has a lower tray 36 which assists to hold it. This magnet is also held within the pouch upon which a variety of fasteners may be removably secured. This improved fastener holding device is an improvement over prior art devices such as pouches, which limits the ability of the user to withdraw fasteners, and further can cause pain and injury to the user as fingers are poked when attempting to remove a fastener from within a pouch. While in the preferred present embodiment all three of these features are shown, it is to be distinctly understood that the various pieces of this device may also be embodied and utilized separately with other prior art embodiments. It is also to be distinctly understood that various obvious modifications may also take place while with these devices, which modifications would also be included with and disclosed of the present invention.

In this preferred embodiment, the hammer holster 10 is shown with the handle of the hammer in a generally upright position and held in place by the tab and clasp. In use, a user could certainly remove the hammer handle from within this location upon by simply pushing upon the hammer handle with sufficient force so as to pop the handle out of its held position within the clasp. When this occurs, the natural weight of the handle would rotate the handle into a generally linear orientation where the handle can then be grasped by a user and positioned for use.

The hammer holster body 12 could be made of a variety of materials, including but not limited to, plastics having various properties of thickness and strength, leather, metal, and other devices. In addition to the magnetic portion 14, which must be rotatably connected, it may have different shapes according to the needs and necessities of the user.

FIG. 6 shows the use of the wire cutter of the preferred embodiment with the hammer. In the preferred embodiment, the handle portion of the pliers of the wire cutters is configured for insertion within the hammer. In the same embodiment, these wire cutters may be permanently attached, or removably attached according to the needs of a user. This feature provides several advantages to a user in that a user would no longer be required to use two separate tools, but could simply use one tool for both hammering as well as for cutting wire while running wire in a desired location. These features provide significant advantages to the user, and allow them to more quickly and efficiently work to place items in desired locations.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A system of tools for electricians comprising:
a hammer, said hammer having a head with a single claw, said head fixedly connected to a handle, said handle having a handle body, said handle body configured to receive a handle of a wire cutting device therein, said head of said hammer configured for removable magnetic connection with a portion of a holster, said handle body further connected to a wire cutting device, said wire cutting device comprised of a pair of jaws pivotally connected at a pivoting location, each of said jaws further connected to a lever arm whereby application of force upon said levers causes said jaws to move toward one another with sufficient force to cut a wire of a pre-selected thickness;
said holster configured for connection with said hammer, said holster comprising a holster body, said holster body having a first end configured for pivotable connection with a belt connecting device and extending along a generally dogleg shaped body to a second end, said second end having a magnet rotatingly connected thereto, said holster further comprising a handle gripping clasp fixedly connected to the holster body, said handle gripping clasp comprised of a generally C-shaped body, said generally C-shaped body configured to receive said handle of said hammer therein; and
a fastener retaining device comprised of a magnetic member having a portion configured for connection with a belt.

2. The system of tools of claim 1 wherein said hammer head is a metallic hammer head having a weight of less than sixteen ounces.

3. The system of tools of claim 1 wherein said jaws of said wire cutting device further define a plurality of apertures, said apertures configured to cut insulation from a wire while leaving the wire core intact.

4. The system of tools of claim 1 wherein one of said levers of said wire-cutting device is removably connected within said handle of said hammer.

5. The system of tools of claim 1 wherein said single claw has a generally spoon billed shape portion, said spoon bill shaped portion configured to allow a user to remove fasteners from a location without incurring damage to an underlying surface.

6. The system of tools of claim 1 wherein said gripping clasp further comprises a tab, said tab configured to retain a portion of said handle member within said clasp.

7. The system of tools of claim 1 wherein the holster body has non-linear configuration and wherein the alignment between the connection with the belt and the connection of the magnetic retaining portion with the holster body do not lie in the same vertical plane when the holster is connected to a belt.

8. The system of tools of claim 1 wherein said holster body is made of a generally plastic material.

9. The system of tools of claim 1 wherein said single claw is dimensioned so as to allow a user to punch out apertures of a pre-selected size within pre-selected electrical connecting hardware devices.

10. A hammer holding holster comprising:
a hammer holding holster, said hammer holding holster configured for connection with said hammer, said holster comprising a holster body said holster body having a first end configured for pivotable connection with a belt connecting device and extending along a body to a second end, said second end having a magnet rotatingly connected thereto, said magnet having sufficient strength whereby a hammer head is magnetically held against said magnet with sufficient force whereby a hammer is suspendingly attached to said hammer holster.

11. The hammer holster of claim 10 further comprising a handle gripping clasp fixedly connected to the holster body, said handle gripping clasp comprised of a generally C-shaped body, said generally C-shaped body configured to receive said handle of said hammer within a groove defined therein; said clasp hammer holster configured to orient said hammer in a handle upward position.

12. An electrician's hammer comprising:
a hammer, said hammer comprising a head fixedly connected to a handle, said head comprising a single claw, said single claw having a generally spoon bill shaped portion, said spoon bill shaped portion configured to allow a user to remove fasteners from a location without incurring damage to an underlying surface.

13. The electrician's hammer of claim 12 further comprising a wire cutting device, said wire cutting device comprised of a pair of jaws, each of said jaws having a cutting surface connected thereto, each of said jaws pivotally connected at a pivoting location, each of said jaws further connected to a lever arm whereby application of force upon said levers causes said jaws to move toward one another with sufficient force to cut a wire of a pre-selected thickness.
